(19) United States
(12) Patent Application Publication
(10) Pub. No.: US 2026/0084269 A1
(43) Pub. Date: Mar. 26, 2026

(54) ADJUSTABLE WRENCH DEVICE FOR INSTALLATION AND REMOVAL OF THREADED CONNECTORS

(71) Applicant: BLUE ORIGIN, LLC, KENT, WA (US)

(72) Inventors: Mitchell Troublefield, Kent, WA (US); Derek Klopp, Kent, WA (US)

(21) Appl. No.: 18/898,294

(22) Filed: Sep. 26, 2024

(51) Int. Cl. B25B 13/14

(52) U.S. Cl. CPC B25B 13/14

(57) ABSTRACT

Systems and methods are directed toward adjustable-span torquing devices that can be used to install and remove threaded connectors. An adjustable wrench head can be used which includes a main portion and an adjustable portion, both including at least one surface to contact a threaded connector. The adjustable portion may be movably connected to the main portion. The adjustable wrench head may use an adjustment mechanism that can be actuated to adjust the secondary surface of the adjustable portion relative to the surface of the main portion into contact with the threaded connector. The secondary surface and the primary surface may be positioned to apply torque to the threaded connector in response to a rotation of the main portion and the adjustable portion to engage or disengage the threaded connector with a threaded opening. The adjustable wrench head can be dimensioned to adjust to receive multiple sizes of 38999-type connectors.

### TECHNICAL FIELD

Developments disclosed and suggested herein relate generally to adjustable torquing tools that can be used to accurately apply high torque values to multiple sizes of threaded connectors, and in particular to adjustable wrench heads that include adjustable spans to correspond with knurled surfaces such as knurled surfaces of D38999-type connectors.

### BACKGROUND

Threaded connectors are used in bulk across industries and therefore are often provided in standardized sizes and specifications. However, threaded connects can be required for use in harsh conditions not considered under standard speciation, including strong vibrations, shock, moisture, wind, variable environments, or extreme temperatures, including aerospace, automotive, military, and marine applications. To ensure lasting security of threaded connectors, high torque values can be required for installation and corresponding removal. Additionally, high torque values can be required to be accurately and repeatedly applied without causing damage to the surface gripped by the torquing tool. While adjustable torquing tools for connectors exist which can be used with threaded connectors, these tools generally do not allow for applying high torque without damaging the connector surface while providing a compact and robust form.

### SUMMARY

Disclosed herein are adjustable wrench tools, and similar torquing devices, which are able to be used to torque multiple sizes of threaded connectors. Various embodiments may include configurations where a self-adjusting torque tool includes a heel jaw, a hook jaw, and a pinion gear. The heel jaw can have a contact surface dimensioned to grip a knurled surface of a threaded connector, and a tool body. The hook jaw can have one or more contact surfaces dimensioned to grip the knurled surface of the threaded connector, and a rack movably secured to the tool body having a plurality of teeth. The heel jaw and the hook jaw can define a span to receive the threaded connector. The pinion gear can be secured at least partially within the tool body and mated with the rack of the hook jaw. The pinion gear can be turned to cause the rack to translate and move the heel jaw contact surface and the one or more hook jaw contact surfaces between a minimum distance and a maximum distance to grip the knurled surface of the threaded connector in the span. The heel jaw contact surface and the one or more hook jaw contact surfaces can move together with the heel jaw and the hook jaw to rotate the threaded connector when gripping the knurled surface.

Various embodiments may include adjustable wrench heads that each include a main portion, an adjustable portion, and an adjustment mechanism. The main portion can have a primary surface to contact a rotatable connector. The adjustable portion can have a secondary surface dimensioned to contact the rotatable connector. The adjustable portion may be movably connected to the main portion. The adjustment mechanism can be actuated to adjust the secondary surface of the adjustable portion relative to the surface of the main portion into contact with the rotatable connector. The primary surface and the secondary surface may be positioned to apply torque, in response to a rotation of the main portion and the adjustable portion, to the contacted rotatable connector.

Various embodiments allow for rotating of a threaded connector using an adjustable wrench device. One or more knurled surfaces, knurled surface edges, or partial knurls, of the threaded connector can be received within a span of the adjustable wrench device. The span may include at least a first contact surface and a second contact surface dimensioned to engage at least partially the one or more knurled surfaces. The span of the adjustable wrench device can be adjusted in order to cause the first contact surface to move toward the second contact surface and engage the threaded connector. A force can be applied to the adjustable wrench device to rotate the threaded connector using the first contact surface and the second contact surface engaged with the one or more knurled surfaces.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. It will be readily understood that the aspects of the present disclosure, as generally described herein, and illustrated in the figures, can be arranged, substituted, combined, and designed in a wide variety of different configurations, all of which are explicitly contemplated and make part of this disclosure. As noted above, the drawings as depicted are not necessarily drawn to scale. The relative dimensions and proportions as shown are not intended to limit the present disclosure, unless indicated otherwise. Various embodiments in accordance with the present disclosure will be described with reference to the drawings, in which:

FIG. 1 illustrates a perspective view of an adjustable wrench head dimensioned for multiple sizes of threaded connectors, in accordance with at least one embodiment;

FIG. 2 illustrates a perspective view of a partially disassembled adjustable wrench head including an adjustment mechanism, in accordance with at least one embodiment;

FIG. 3 illustrates an exploded view of an adjustable wrench head dimensioned for multiple sizes of threaded connectors, in accordance with at least one embodiment;

FIG. 4 illustrates a front view of an example adjustable wrench head engaged with a threaded connector, in accordance with at least one embodiment;

FIG. 5 illustrates a front view of another example adjustable wrench head engaged with a threaded connector, in accordance with at least one embodiment; and

FIG. 6 illustrates an example process that can be performed to rotate a threaded connector using an adjustable wrench device, in accordance with at least one embodiment.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. It should be further appreciated that terms such as approximately or substantially may indicate +/−10 percent.

As used herein, a connector may refer to a fastening device that may be used in cooperation with at least another device or body to create or separate from a secure attachment in response to rotational operation. The connector can be a threaded connector able to be secured with a threaded body, such as a connector ring able to couple with a counterpart connector receptacle. The connector can also be substantially circular or cylindrical and include one or more surfaces to interface with a tool to rotate the connector. The connector can be a 38999-style connector, such as a connector manufactured to a MIL-DTL 38999 or D38999 specification, including Series I, Series II, Series III, and Series IV. The connector may be available in multiple sizes, such as having multiple available diameters of the surface to interface with a tool to rotate the connector. The connector can be used to couple electrical or communication transfer systems, such as fiber optic, twinax, coax, quadrax, PC, or other systems, by providing one or more of signal, power, and data. The connector can include one or more surfaces for interfacing with a user, tool, or wrench. The interfacing surfaces can include texture, such as knurls, and can also include smooth portions, such as scallops, grooves, flutes, flats, or slots. The complete coupling of the connector may be achieved with a number of turns, revolutions, or degrees, such as one 360-degree turn. The connector can be a portion of multi-part assembly, such as nut or bolt, electrical connector, paired rotary fastener, or other assembly.

As used herein, an adjustable wrench may refer to a torquing device, such as a wrench head or a spanner which is adjust able to interface with a connector or connectors of different sizes, such as by gripping a rotatable surface. The adjustable wrench can be used to rotate the connector, such as to install or remove the connector from another device or body. The adjustable wrench can include a first portion such as a heel jaw, main body, or handle to grip a connector. The adjustable wrench can include a second portion such as an hook jaw, adjustable body, or arm to grip a connector. The adjustable wrench can adjust to receive and grip connectors of multiple sizes or diameters. The adjustable wrench can interface with a connector using textured surfaces to increase the amount of torque that can be applied from the adjustable wrench. The adjustable wrench can include a profile which includes a variable opening, void, or span to, at least partially, receive and contact the connector.

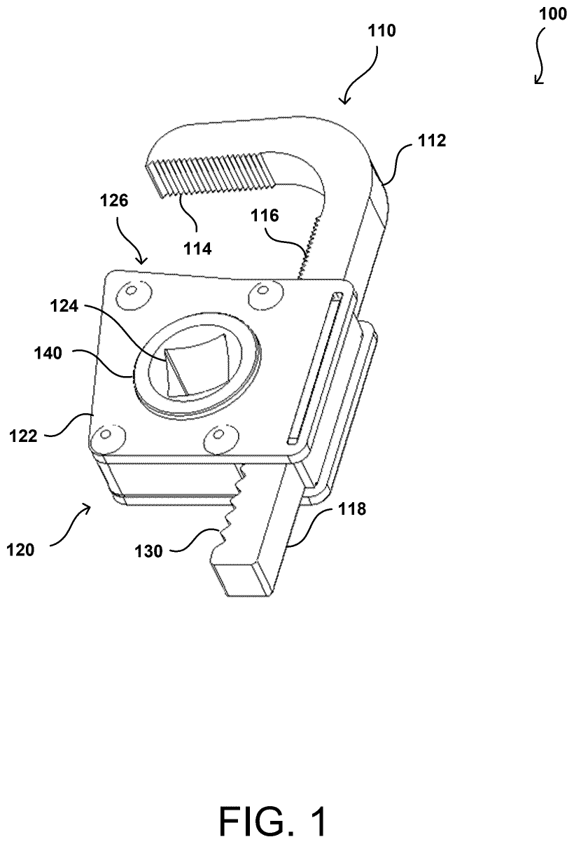

FIG. 1 illustrates a perspective view of an adjustable wrench head 100 dimensioned for multiple sizes of threaded connectors in accordance with at least one embodiment. As illustrated, the adjustable wrench head 100 includes a hook jaw 110 and a heel jaw 120, which are typically formed from a metal, such as stainless steel or other suitable material, and may have a compact size and shape. The hook jaw 110 may include a first portion 112 able to engage with a threaded connector, and a second portion 118 able to engage with the heel jaw 120. The heel jaw 120 may include a main body 122 able to engage with at least the second portion 118 the hook jaw 110. The hook jaw 110 and the heel jaw 120 may define a span of the adjustable wrench head 100. The hook jaw 110 may include a first hook jaw contact surface 114 and a second hook jaw contact surface 116 which are able to contact or grip the threaded connector. The hook jaw 110 may include only a single contact surface or may include more than two contact surfaces. The first hook jaw contact surface 114 and a second hook jaw contact surface 116 may be positioned on an interior surface of the hook jaw 110. The heel jaw 120 may include at least one heel jaw contact surface 126 which is able to contact or grip the threaded connector. The heel jaw contact surface 126 may be positioned on an interior surface of the hook jaw 110. The contact surfaces of the hook jaw 110 and the heel jaw 120 may at least partially define a span of the adjustable wrench head 100. In an example, first portion 112 of the hook jaw 110 may include a top section, such as including the first hook jaw contact surface 114, which is at least substantially perpendicular, or at a right angle, to a side section, such as including the second hook jaw contact surface 116, of the hook jaw 110. One or more of the hook jaw contact surfaces 114, 116 may oppose or be substantially opposite to the heel jaw contact surface 126. One or more of the contact surfaces 114, 116, 126 may be on a plane perpendicular to one or more of the other contact surfaces 114, 116, 126. In an example, the second hook jaw contact surface 116, may be at least substantially angled to one or both of the first hook jaw contact surface 114 and the heel jaw contact surface 126.

The main body 122 of the adjustable wrench head 100 may include an input 124 to receive an torquing extension, such as a handle, ratcheting mechanism, powered rotating shaft, or other device, which can extend the length of the adjustable wrench head 100. The extension may be permanently integrated into the adjustable wrench head 100 or main body 122. The extension may be able to increase leverage of the adjustable wrench head. The adjustable wrench head 100 may be adjusted to receive or correspond with multiple sizes of threaded connectors. Adjustment of the adjustable wrench head 100 may move the first portion 112 of the hook jaw 110 relative to the heel jaw 120 or may move the heel jaw 120 relative to the hook jaw 110. Adjustment of the adjustable wrench head 100 may cause one or more of the first hook jaw contact surfaces 114 and the second hook jaw contact surface 116 relative to the heel jaw contact surface 126, and may change the span of the adjustable wrench head 100 and/or the distance between one or more of the first hook jaw contact surfaces 114 and the second hook jaw contact surface 116. The adjustment may allow the adjustable wrench head 100 to receive different size connectors, such as D38999-type Series 3 connectors.

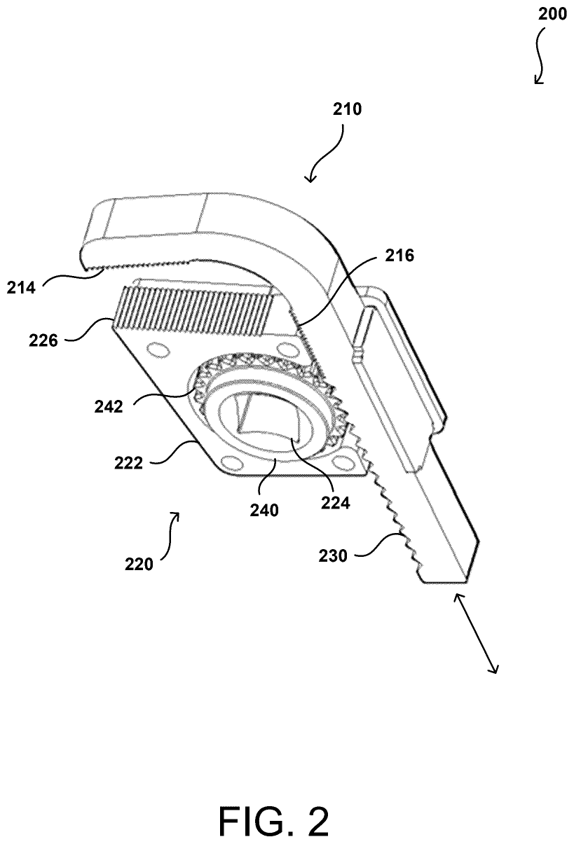

The adjustable wrench head 100 be adjusted to receive a threaded connector using an shifting mechanism or adjustment mechanism, such as a rack and pinion gear, hand-turned knob, friction fit slide, or other mechanism. The second portion 118 of the hook jaw 110 may include a rack 130 of the adjustment mechanism, the rack 130 including a number of notches. The rack 130 may be used to move or translate the hook jaw 110 or first portion 112. The main body 122 of the heel jaw 120 may include a pinon gear 140 of the adjustment mechanism, the pinon gear 140 including a number of gears, not shown. The rack 130 and the pinion gear 140 may interact to move or translate the first portion 112 of the hook jaw 110 relative to the heel jaw 120 in response to rotation of the pinion gear 140 as illustrated more clearly in FIG. 2. The second portion 118 of the hook jaw 110 may include a pinion gear of the adjustment mechanism and the main body 122 of the heel jaw 120 may include a rack of the adjustment mechanism. The pinion gear 140 of the heel jaw 120 may include the input 124. The pinion gear 140 may be actuated, such as turned or moved, using an extension received in input 124. When the hook jaw 110 and the heel jaw 120 are in contact with the threaded connector, such as by rotation of the pinion gear 140 using a ratcheting handle, continuing rotation of the pinion gear 140 in the same direction may cause one or more of the first hook jaw contact surfaces 114 and the second hook jaw contact surface 126 in contact with the threaded connector to rotate the threaded connector.

One or more portions or sections of the adjustable wrench head 100 may be increased in size, reduced in size, reinforced, strengthened, or otherwise modified in order to provide desired characteristics. For example, the width of the adjustable wrench head 100 may be minimized to provide a compact for an low weight, such as about 0.188 inch in thickness, however the thickness may be from about 0.030 inch to about 0.250 inch, about 0.001 inch to about 0.030 inch, about 0.250 inch to about 1.000 inch, about 1.000 inches to about 5.000 inches, or other suitable thickness. The adjustable wrench head 100 may be required to fit through a gap between a connector and a receptable or threaded opening.

FIG. 2 illustrates a perspective view of a partially disassembled adjustable wrench head 200 including an adjustment mechanism in accordance with at least one embodiment. The adjustable wrench head 200 includes a hook jaw 210 and a heel jaw 220 which define an open end and a span able to receive a rotatable connector of one or more sizes. The hook jaw 210 may include a first hook jaw contact surface 214 and a second hook jaw contact surface 216 able to grip the rotatable connector. The heel jaw 220 may include a heel jaw contact surface 226 able to grip the rotatable connector. The hook jaw 210 may include a rack 230 as part of an adjustment mechanism. The heel jaw 220 may include a housing or main body 222 with an internal cavity able to maintain a pinion gear 240 as part of an adjustment mechanism. The pinion gear 240 may include a number of gear teeth 242 able to cooperate with the rack 230 to adjust the span size of the adjustable wrench head 200. As the pinion gear 240 turns, the gear teeth 242 may push or pull the rack 230 to move or translate the hook jaw 210. When the gear teeth 242 reach an end of the rack 230, such as when griping the smallest or largest size rotatable connector, a force applied to the pinion gear 240 can then be applied to the rotatable connector as rotational motion. The gear teeth 242 and the cooperating surface of the rack 230 may be more or less coarse which may change the leverage, speed of translation of the rack, accuracy of the adjustment, robustness, or other qualities.

The adjustable wrench head 200 may be self-adjusting to receive multiple sizes of rotatable connectors. The input 224 may be position in the pinion gear 240 to receive a handle used apply torque to rotate the rotatable connector. As the handle is used to apply torque to the adjustable wrench head 200, the pinion gear 240 can be used to self-adjust the adjustable wrench head 200, such as to close the first hook jaw contact surface 214, the second hook jaw contact surface 216, and the heel jaw contact surface 226 on the rotatable connector. When the adjustable wrench head 200 grips the rotatable connector after self-adjusting, torque may continue to be applied to rotate the rotatable connector. One or more parts or portions of parts of the adjustable wrench head 200 may have a reduced size, such as to prevent unwanted interference with a rotatable connector or provide a more compact adjustable wrench head 200 to prevent interference with other objects in a work area.

The adjustable wrench head 200 may include a soft jaw which uses a material, such as silicone, plastic, vinyl, brass, or other suitable material, to cover at least a portion of one or more of the first hook jaw contact surface 214, the second hook jaw contact surface 216, or the heel jaw contact surface 226. Other portions or parts of the adjustable wrench head 200 may include metals, such as stainless steel. The soft jaw may be removable or may be permanently affixed to the adjustable wrench head 200. The use of the soft jaw for the adjustable wrench head 200 may increase the friction and/or reduce slippage between the adjustable wrench head 200 and the rotatable connector, and may reduce marring, gouging, or damage to the rotatable connector. One or more parts of the adjustable wrench head 200 may be manufactured by milling, sheet cutting, including water jet and laser cutting, or other suitable methods.

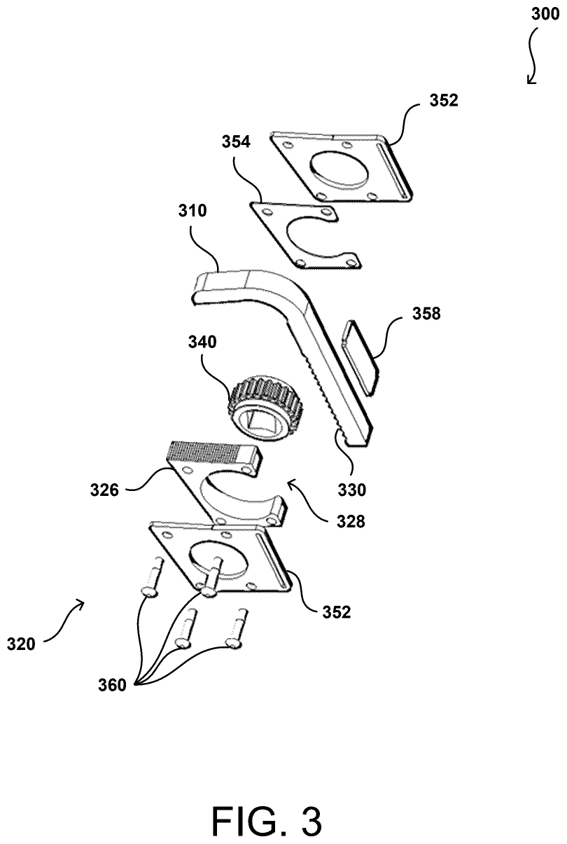

FIG. 3 illustrates an exploded view of an adjustable wrench head 300 including an adjustment mechanism in accordance with at least one embodiment. The adjustable wrench head 300 may have an adjustable jaw 310 having a rack 330. The adjustable wrench head 300 may have a fixed jaw 320 positioned relative to the adjustable jaw 310 to receive a workpiece. The adjustable jaw 310 may be able to translate or move relative to the fixed jaw 320. The fixed jaw 320 may also have a heel body 326 including an internal cavity 328 to receive a pinion gear able to operate the rack 330 which can cause translation of the adjustable jaw 310.

The fixed jaw 320 may also include one or more housing assemblies to maintain cooperation of the adjustable jaw 310 with the fixed jaw 320. The housing assemblies may include a pair of side plates 352 positioned on either side of the adjustable jaw 310 and the fixed jaw 320. The pair of side plates 352 may be able to prevent lateral motion of the rack 330 away from the pinion gear 340, and may also be able to maintain the pinion gear 340 within the internal cavity 328 of the fixed jaw 320. The housing assemblies may include one or more gaskets or spacers 354 which may be used to provide appropriate dimensions, prevent contact between some parts, improve resilience of the adjustable wrench head 300, or provide other qualities. The gaskets or spacers 354 may be positioned between suitable parts and may be shaped, sized, or made of suitable materials. The housing assemblies may include a cover 358 located between the pair of side plates 352 and adjacent the adjustable jaw 310. The cover 358 may be held in position by the pair of side plates 352 and prevent the adjustable jaw 310 from being pushed away from the fixed jaw 320 as the pinion gear 340 cooperates with the rack 330. The housing assemblies may include one or more fasteners 360, such as a rivet, bolt and nut, screw, or other fastener able to provide secure attachment of the adjustable wrench head 300. In an example, four fasteners 360 may be used to at least partially secure the adjustable wrench head 300 by passing through the first side plate 352, the heel body 236, the gasket or spacer 354, and the second side plate 352. Securing of the adjustable wrench head 300 may enable the actuation of the adjustment mechanism by providing dimensions for the rotation of the pinion gear 340 and corresponding translation of the rack 330.

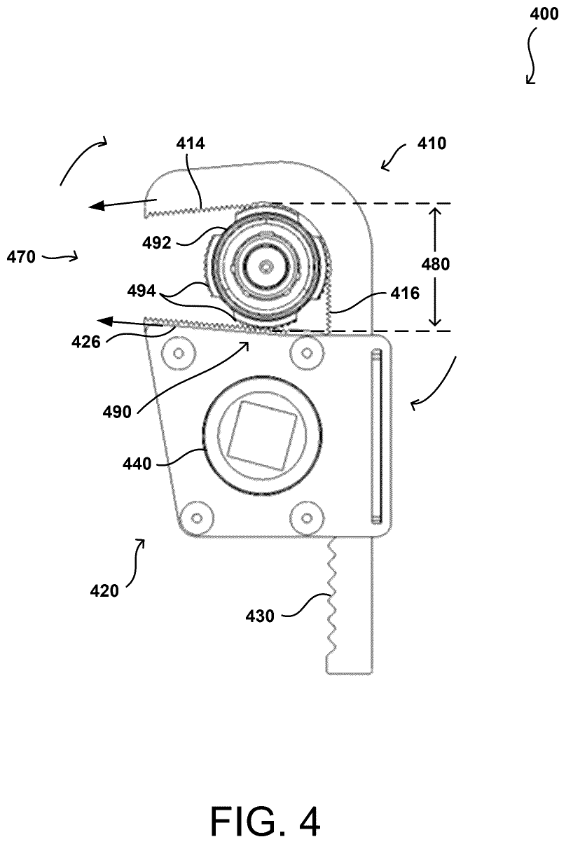

FIG. 4 illustrates a front view of an example adjustable wrench head 400 engaged with a threaded connector 490 in accordance with at least one embodiment. The adjustable wrench head 400 may include a hook jaw device 410 and a heel jaw device 420 which may at least partially define a span or opening 470 to receive a threaded connector 490 of various sizes. The distance 480 of the span or the opening 470 may be changed using an adjustment mechanism, such as a rack 430 and a pinion gear 440, where the pinion gear 440 may be rotated to translate the rack 430. In an example, the adjustable wrench head 400 may be able to be adjusted to receive, between the hook jaw device 410 and the heel jaw device 420, a 38999 Series III connector with a shell size of 09, 11, 13, 15, 17, 19, 21, 23, and 25. To receive the 38999 Series III connectors, the distance 480 of the span or opening 470 may be able to be adjusted from about 0.75 inch to about 2.00 inches, about 0.25 inch to about 2.25 inches, about 0 inch to about 2.50 inches, about 1.00 inches to about 10.00 inches, or other suitable lengths. In an example, the distance 480 of the span or opening 470 may be able to be adjusted from about 0.01 inch to about 0.10 inch, about 0 inch to about 20.00 inches, or other suitable lengths. The threaded connector 490 may be a cylindrical electrical connector that may be rotatably attached to a threaded receptacle. The threaded connector 490 may have an outer surface including one or more scalloped, grooved, fluted, slotted, or flat surfaces 492 and one or more textured or knurled surfaces 494 that may be gripped by a user or tool, such as adjustable wrench head 400, to rotate the threaded connector 490 about an axis, such as the centerline of the threaded connector 490. The threaded connector 490 may include a set of threads which mate with a set of corresponding threads of a threaded receptacle. Rotation of the threaded connector 490 around the axis may cause the threads to interface with the threads of the threaded receptacle, causing loosening or tightening of the threaded connector 490. The adjustable wrench head 400 may be moved over or around the threaded connector 490 so the threaded connector 490 is substantially within a span or opening 470 of the adjustable wrench device 400.

The knurled surfaces 494 of the threaded connector 490 may include a pattern or knurl, which may be able to increase the grip or friction that can be applied to the threaded connector 490. The adjustable wrench head 400 may have a top jaw surface 414, side jaw surface 416, and bottom jaw surface 460 may be able to contact or grip the threaded connector 490. One or more of the jaw surfaces 414, 416, 426 may be sized to grip across or over a flat surface 492 of the threaded connector. One or more of the jaw surfaces 414, 416, 426 may include a pattern or knurl, which may be able to increase the grip or friction that can be applied from the adjustable wrench head 400. One or more of the jaw surfaces 414, 416, 426 may be smooth or substantially smooth. The knurl of the adjustable wrench head 400 may correspond, at least partially to the knurl of the knurled surfaces 494. One or more of the jaw surfaces 414, 416, 426 may be able to engage at least partially with the knurled surfaces 494 of the threaded connector 490. The texture or knurl of the jaw surfaces 414, 416, 426 and/or the knurled surfaces 494 may be straight, diamond, left or right-handed, cross, beveled, or other suitable patters. The jaw surfaces 414, 416, 426 may be formed to minimize gouging or other damage to the threaded connector 490 and may be formed to reduce slippage between the adjustable wrench head 400 and the threaded connector 490. The adjustable wrench head 400 may have more or less than the three jaw surfaces 414, 416, 426 to interface with the threaded connector 490, such as two, four, or five jaw surfaces which are positioned to interface with the knurled surfaces 494 of the threaded connector 490. The jaw surfaces 414, 416, 426 can be positioned apart to provide at least three points of contact with the threaded connector 490.

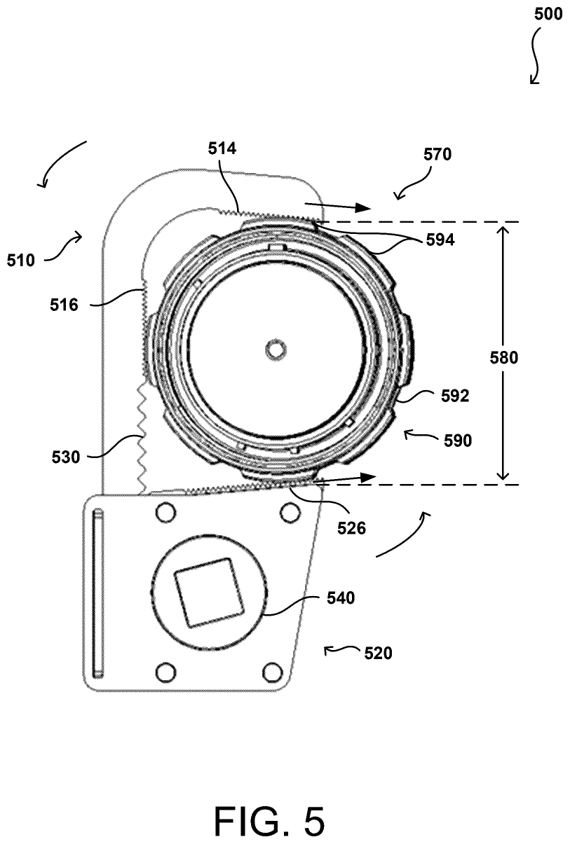

The adjustable wrench head 400 may be adjusted, such as using an adjustment mechanism or assembly, for use with multiple sizes of the threaded connector 490. As shown in FIG. 4, the adjustable wrench head 400 may be adjusted to receive the threaded connector 490 having a diameter requiring the jaw surfaces 414, 416, 426 to be positioned with the shortest distance 480. In an example, the threaded connector 490 may be a D38999 Series III connector with a shell size of 09, where the distance 480 is the shortest possible distance, or substantially close to the shortest possible distance and the pinion gear 440 may be positioned at a closest end of the rack 430 path or substantially close to the closest end of the rack 430 path. In this example, when grasped by the adjustable wrench head 400, the knurled surfaces 494 of the threaded connector 490 may contact only inner portions of the jaw surfaces 414, 416, 426, such as near inward edges. After adjusting the adjustable wrench head 400 and the pinion gear 440 is positioned at the close end of the rack 430 path, a force applied to turn the pinion gear 440 and translate the rack 430 may be transferred from the jaw surfaces 414, 416, 426 to the knurled surfaces 494 of the threaded connector 490 to cause rotation of the threaded connector 490 with the adjustable wrench head 400. The force applied to a handle may be transferred to the adjustable wrench head 400 to cause clockwise rotation. The jaw surfaces 414, 416, 426 extending inwardly from the hook jaw device 410 and the heel jaw device 420 may include one or more surfaces that are able to interface with the threaded connector 490. As the force is applied to the adjustable wrench head 400, the jaw surfaces 414, 416, 426 may grip the knurled surfaces 494, providing a torque and twisting the threaded connector 490 clockwise. The threaded connector 490 may first be hand-tightened, and then fully tightened on the threaded receptacle using the adjustable wrench head 400. The threaded connector 490 may be first loosened using the adjustable wrench head 400, and then fully removed from the threaded receptacle by hand. The jaw surfaces 414, 416, 426 may be able to apply high torque values to the threaded connector 490, such as up to at least 180 inch/pounds, 300 inch/pounds, 500 inch/pounds, or other suitable amounts. The rotation of the threaded connector 490 from the force may be in the same direction that the pinion gear 440 was rotated. The rotation of the pinion gear 440 in the opposite direction may translate the rack 430 away from the end the rack 430 path causing the jaw surfaces 414, 416, 426 to move away from the threaded connector 490 and release the connection. In order to rotate the threaded connector 490 in the opposite direction, the adjustable wrench head 400 be flipped, turned over, or reversed and then positioned with the threaded connector 490, as illustrated in FIG. 5. The adjustable wrench head 400 may include a locking mechanism, such as a movable pin or switch, which can be engaged to prevent movement of the pinion gear 440 and/or the rack 430. Engaging the locking mechanism may enable the threaded connector 490 to be rotated in the opposite direction without reversing the adjustable wrench head 400.

One or more of the jaw surfaces 414, 416, 426 may be at least partially angled, such as angled inward or outward. The angle of one or more of the jaw surfaces 414, 416, 426 may be able to position the threaded connector 490 correctly or more securely, such as to draw or pull the threaded connector 490 into the span or opening 470 or against points of contact of the adjustable wrench head 400. The angle of one or more of the jaw surfaces 414, 416, 426 may be from about 0.01 degree to about 1.00 degree, about 1.00 degree to about 5.00 degrees, about 2.00 degrees to about 15.00 degrees, about 10.00 degrees to about 22.50 degrees, or other suitable angles. The top jaw surface 414 may be angled inward toward threaded connector 490, the side jaw surface 416, the bottom jaw surface 426, the heel jaw device 420, and/or other suitable direction. The side jaw surface 416 may be angled inward toward threaded connector 490, the top jaw surface 414, the bottom jaw surface 426, the heel jaw device 420, and/or other suitable direction. The bottom jaw surface 426 may be angled inward toward threaded connector 490, the side jaw surface 416, the top jaw surface 414, the hook jaw device 410, and/or other suitable direction. One or more of the jaw surfaces 414, 416, 426 may be at least partially smooth, substantially smooth, knurled differently that the other jaw surfaces, or include other properties which may be able to allow the threaded connector 490 to be positioned correctly or more securely, such as enabling the threaded connector 490 to be drawn or pulled.

FIG. 5 illustrates a front view of another example adjustable wrench head 500 engaged with a threaded connector 590 in accordance with at least one embodiment. In an example, the adjustable wrench head 400 of FIG. 4 may be illustrated as engaged with a threaded connector 490 having a smaller diameter and the adjustable wrench head 500 of FIG. 5 may be illustrated as engaged with a threaded connector 590 having a larger diameter. The adjustable wrench head 500 may include a hook jaw device 510 and a heel jaw device 520 which may at least partially define a span or opening 570 to receive a threaded connector 590 of various sizes. The distance 580 of the opening 570 may be changed using an adjustment mechanism, such as a rack 530 and a pinion gear 540, where the pinion gear 540 may be rotated to translate the rack 530. In an example, the adjustable wrench head 500 may be able to be adjusted to receive, between the hook jaw device 510 and the heel jaw device 520, a D38999 Series III connector with a shell size of 09, 11, 13, 15, 17, 19, 21, 23, and 25. To receive the D38999 Series III connectors, the distance 580 of the opening 570 may be able to be adjusted from about 0.75 inch to about 2.00 inches, about 0.25 inch to about 2.25 inches, about 0 inch to about 2.50 inches, about 1.00 inches to about 10.00 inches, or other suitable lengths. In an example, the distance 580 of the opening 570 may be able to be adjusted from about 0.01 inch to about 0.10 inch, about 0 inch to about 20.00 inches, or other suitable lengths. The threaded connector 590 may be a cylindrical electrical connector that may be rotatably attached to a threaded receptacle. The threaded connector 590 may have an outer surface including one or more scalloped, grooved, fluted, slotted, or flat surfaces 592 and one or more textured or knurled surfaces 594 that may be gripped by a user or tool, such as adjustable wrench head 500, to rotate the threaded connector 590 about an axis, such as the centerline of the threaded connector 590. The threaded connector 590 may include a set of threads which mate with a set of corresponding threads of a threaded receptacle. Rotation of the threaded connector 590 around the axis may cause the threads to interface with the threads of the threaded receptacle, causing loosening or tightening of the threaded connector 590. The adjustable wrench head 500 may be moved over or around the threaded connector 590 so the threaded connector 590 is substantially within a span 570 the adjustable wrench head 500.

The knurled surfaces 594 of the threaded connector 590 may include a pattern or knurl, which may be able to increase the grip or friction that can be applied to the threaded connector 590. The adjustable wrench head 500 may have a top jaw surface 514, side jaw surface 516, and bottom jaw surface 526 may be able to contact or grip the threaded connector 590. One or more of the jaw surfaces 514, 516, 526 may be sized to grip across or over a scalloped, grooved, fluted, slotted, or flat surface 592 of the threaded connector. One or more of the jaw surfaces 514, 516, 526 may include a pattern or knurl, which may be able to increase the grip or friction that can be applied from the adjustable wrench head 500. One or more of the jaw surfaces 514, 516, 526 may be smooth or substantially smooth. The knurl of the adjustable wrench head 500 may correspond, at least partially to the knurl of the knurled surfaces 594. One or more of the jaw surfaces 514, 516, 526 may be able to engage at least partially with the knurled surfaces 594 of the threaded connector 590. The texture or knurl of the jaw surfaces 514, 516, 526 and/or the knurled surfaces 594 may be straight, diamond, left or right-handed, cross, beveled, or other suitable patters. The jaw surfaces 514, 516, 526 may be formed to minimize gouging or other damage to the threaded connector 590 and may be formed to reduce slippage between the adjustable wrench head 500 and the threaded connector 590. The adjustable wrench head 500 may have more or less than the three jaw surfaces 514, 516, 526 to interface with the threaded connector 590, such as two, four, or five jaw surfaces which are positioned to interface with the knurled surfaces 594 of the threaded connector 590. The jaw surfaces 514, 516, 526 can be positioned apart to provide at least three points of contact with the threaded connector 590.

The adjustable wrench head 500 may be adjusted, such as using an adjustment mechanism or assembly, for use with multiple sizes of the threaded connector 590. As shown in FIG. 5, the adjustable wrench head 500 may be adjusted to receive the threaded connector 590 having a diameter requiring the jaw surfaces 514, 516, 526 to be positioned with the longest distance 580. In an example, the threaded connector 590 may be a D38999 Series III connector with a shell size of 25, where the distance 580 is the longest possible distance, or substantially close to the longest possible distance and the pinion gear 540 may be positioned at a farthest end of the rack 530 path or substantially close to the farthest end of the rack 530 path. In this example, when grasped by the adjustable wrench head 500, the knurled surfaces 594 of the threaded connector 590 may contact only outer portions of the jaw surfaces 514, 516, 526, such as near outward edges. After adjusting the adjustable wrench head 500 and the pinion gear 540 is positioned at the far end of the rack 530 path, a force applied to turn the pinion gear 540 and translate the rack 530 may be transferred from the jaw surfaces 514, 516, 526 to the knurled surfaces 594 of the threaded connector 590 to cause rotation of the threaded connector 590 with the adjustable wrench head 500. The force applied to a handle may be transferred to the adjustable wrench head 500 to cause counterclockwise rotation. The jaw surfaces 514, 516, 526 extending inwardly from the hook jaw device 510 and the heel jaw device 520 may include one or more surfaces that are able to interface with the threaded connector 590. As the force is applied to the adjustable wrench head 500, the jaw surfaces 514, 516, 526 may grip the knurled surfaces 594, providing a torque and twisting the threaded connector 590 counterclockwise. The threaded connector 590 may first be hand-tightened, and then fully tightened on the threaded receptacle using the adjustable wrench head 500. The threaded connector 590 may be first loosened using the adjustable wrench head 500, and then fully removed from the threaded receptacle by hand. The jaw surfaces 514, 516, 526 may be able to apply high torque values to the threaded connector 590, such as up to at least 180 inch/pounds, 300 inch/pounds, 500 inch/pounds, or other suitable amounts. The rotation of the threaded connector 590 from the force may be in the same direction that the pinion gear 540 was rotated. The rotation of the pinion gear 540 in the opposite direction may translate the rack 530 even further away from the end the rack 530 path causing the jaw surfaces 514, 516, 526 to move away from the threaded connector 590 and release the connection. In order to rotate the threaded connector 590 in the opposite direction, the adjustable wrench head 500 be flipped, turned over, or reversed and then positioned with the threaded connector 590, as illustrated in FIG. 4. The adjustable wrench head 500 may include a locking mechanism, such as a movable pin or switch, which can be engaged to prevent movement of the pinion gear 540 and/or the rack 530. Engaging the locking mechanism may enable the threaded connector 590 to be rotated in the opposite direction without reversing the adjustable wrench head 500.

One or more of the jaw surfaces 514, 516, 526 may be at least partially angled, such as angled inward or outward. The angle of one or more of the jaw surfaces 514, 516, 526 may be able to position the threaded connector 590 correctly or more securely, such as to draw or pull the threaded connector 590 into the span 570 or against points of contact of the adjustable wrench head 500. The angle of one or more of the jaw surfaces 514, 516, 526 may be from about 0.01 degree to about 1.00 degree, about 1.00 degree to about 5.00 degrees, about 2.00 degrees to about 15.00 degrees, about 10.00 degrees to about 22.50 degrees, or other suitable angles. The top jaw surface 514 may be angled inward toward threaded connector 590, the side jaw surface 516, the bottom jaw surface 526, the heel jaw device 520, and/or other suitable direction. The side jaw surface 516 may be angled inward toward threaded connector 590, the top jaw surface 514, the bottom jaw surface 526, the heel jaw device 520, and/or other suitable direction. The bottom jaw surface 526 may be angled inward toward threaded connector 590, the side jaw surface 516, the top jaw surface 514, the hook jaw device 510, and/or other suitable direction. One or more of the jaw surfaces 514, 516, 526 may be at least partially smooth, substantially smooth, knurled differently that the other jaw surfaces, or include other properties which may be able to allow the threaded connector 590 to be positioned correctly or more securely, such as enabling the threaded connector 590 to be drawn or pulled.

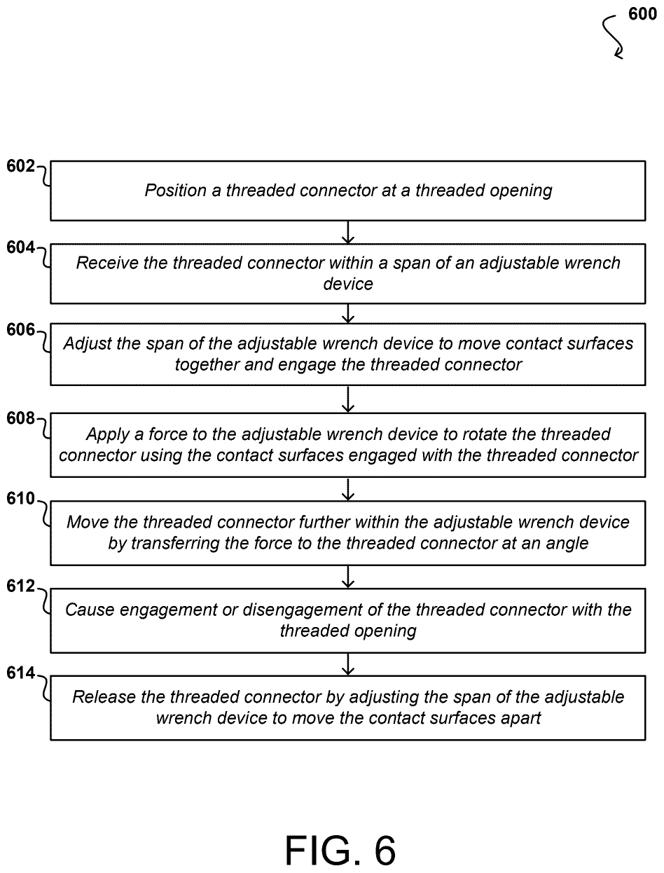

FIG. 6 illustrates an example process 600 to rotate a threaded connector using an adjustable wrench device in accordance with various embodiments. It should be understood that for this and other processes presented herein that there may be additional, fewer, or alternative operations performed in similar or alternative orders, or at least partially in parallel, within the scope of the various embodiments unless otherwise specifically stated. A threaded connector may be positioned 602 at a threaded opening. The threaded connector may be a D38999-type electrical connector of a number of sizes. The threaded connector may be fully engaged with the threaded opening and able to be disengaged using an adjustable wrench device, or may be only minimally or partially engaged, such as hand-tightened, with the threaded opening and able to be engaged using an adjustable wrench device. The threaded connector may be received 604 within an span of adjustable wrench device. The adjustable wrench device may be moved over or around the threaded connector, so the threaded connector is substantially within the adjustable wrench device span. The adjustable wrench device can have a movable jaw and be able to receive a multiple connector sizes. The span may be defined at least in part by the profile or jaws of the adjustable wrench device. A handle can be removably attached to the adjustable wrench device, such as to a main body or an adjustment mechanism.

The span of the adjustable wrench device can be adjusted 606 to move contact surfaces together and engage the threaded connector. The threaded connector may have a surface that is textured or knurled. The one or more of the contact surfaces of the adjustable wrench may be textured or knurled, and may correspond to one or more of the size, shape, position, knurl, texture, or other property of the threaded connector surface, and enable the application of torque from the adjustable wrench device to the threaded connector. The contact surfaces can at least partially define the span of the adjustable wrench device. An adjustment mechanism, such as a rack and pinion gear, may be used to adjust the span. The pinion gear may be connected to a handle, or be able to receive a handle, which can be used to adjust the span. A force can be applied 608 to the adjustable wrench device to rotate the threaded connector using the contact surfaces engaged with the threaded connector. The force can be applied from a handle, such as a ratcheting handle, and transferred through the main body or the pinion gear and the contact surfaces to the threaded connector. The contact surfaces may be able to transfer the torque to turn the threaded connector without marring or damaging the surface of the connector. The threaded connector can be moved 610 further within the adjustable wrench device by transferring the force to the threaded connector at an angle. The one or more of the adjustable wrench device contact surfaces may be angled so the threaded connector is drawn or pushed more securely into the span of the adjustable wrench device, such as before or during rotation.

The threaded connector can be caused 612 to be engaged or disengaged with a threaded opening by the contact surfaces. The rotation provided by the adjustable wrench device using the contact surfaces may cause the threads of the threaded connector and the threads of the threaded body to cooperate. For example, a clockwise rotation may cause engagement, until the connection is fully secure, and a counterclockwise or anticlockwise rotation may cause disengagement, until the connection is fully released. In another example, the converse can be enabled. The threaded connector may be released 614 by adjusting the span of the adjustable wrench device to move the contact surfaces apart. The contact surfaces of the adjustable wrench device may release the threaded connector as the span is widened. The adjustment mechanism may be adjusted to move one or more of the contact surfaces and release the threaded connector. The distance between the contact surfaces may be sized and positioned to release multiple sizes of the threaded connector.

Other variations are within spirit of present description. Thus, while the described techniques are susceptible to various modifications and alternative constructions, certain illustrated embodiments thereof are shown in drawings and have been described above in detail. It should be understood, however, that there is no intention to limit description to specific form or forms described, but on contrary, intention is to cover all modifications, alternative constructions, and equivalents falling within spirit and scope of description, as defined in appended claims.

Terms such as “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on. ”

Use of any and all examples, or exemplary language (e.g., “such as”) provided herein, is intended merely to better illuminate embodiments of the description, and does not pose a limitation on scope of description unless otherwise claimed. No language in specification should be construed as indicating any non-claimed element as essential to practice of the description.

Although descriptions herein set forth example implementations of described techniques, other architectures may be used to implement described functionality, and are intended to be within scope of this description. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are described as exemplary forms of implementing the claims.

What is claimed is:

1. A self-adjusting torque tool, comprising:
a heel jaw having a contact surface dimensioned to grip a knurled surface of a threaded connector, and a tool body;
a hook jaw having one or more contact surfaces dimensioned to grip the knurled surface of the threaded connector, and a rack movably secured to the tool body having a plurality of teeth, wherein the heel jaw and the hook jaw define a span to receive the threaded connector; and
a pinion gear secured at least partially within the tool body and mated with the rack of the hook jaw, wherein the pinion gear is able to be turned to cause the rack to translate and move the heel jaw contact surface and the one or more hook jaw contact surfaces between a minimum distance and a maximum distance to grip the knurled surface of the threaded connector in the span, wherein the heel jaw contact surface and the one or more hook jaw contact surfaces move together with the heel jaw and the hook jaw to rotate the threaded connector when gripping the knurled surface.

2. The self-adjusting torque tool of claim 1, wherein the threaded connector is a D38999 electrical connector.

3. The self-adjusting torque tool of claim 2, wherein the minimum distance is able to receive the D38999 electrical connector of size 9 and the maximum distance being able to receive the D38999 electrical connector of size 25.

4. The self-adjusting torque tool of claim 1, wherein at least one of the heel jaw contact surface or the hook jaw contact surfaces are angled inward.

5. The self-adjusting torque tool of claim 1, wherein the tool body is able to receive a removable ratcheting handle.

6. The self-adjusting torque tool of claim 1, wherein at least one of the heel jaw contact surface or the hook jaw contact surfaces are knurled.

7. The self-adjusting torque tool of claim 1, wherein at least one of the heel jaw contact surface or the hook jaw contact surfaces include a covering comprised of a material softer than the knurled surface of the threaded connector.

8. The self-adjusting torque tool of claim 7, wherein the material is removable.

9. An adjustable wrench head, comprising:
a main portion including a primary surface to contact a rotatable connector, and including an opening to receive a torquing extension;
an adjustable portion including a secondary surface to contact the rotatable connector, the adjustable portion being movably connected to the main portion; and
an adjustment mechanism able to be actuated to adjust the secondary surface of the adjustable portion relative to the primary surface of the main portion into contact with the rotatable connector, the primary surface and the secondary surface positioned to apply torque, in response to a rotation of the main portion and the adjustable portion by the torquing extension, to the contacted rotatable connector.

10. The adjustable wrench head of claim 9, wherein the rotatable connector is a 38999-style connector.

11. The adjustable wrench head of claim 10, wherein the secondary surface and the primary surface are able to be positioned to receive the D38999 electrical connector with a shell size of 09 and the D38999 electrical connector with the shell size of 25.

12. The adjustable wrench head of claim 9, wherein at least one or the primary surface or the secondary surface are angled inward.

13. The adjustable wrench head of claim 9, wherein adjustment mechanism is able to receive the torquing extension.

14. The adjustable wrench head of claim 9, wherein at least one or the primary surface or the secondary surface are knurled.

15. The adjustable wrench head of claim 9, wherein at least one of the primary surface or the secondary surface are at least partially comprised of a material softer than the rotatable connector.

16. The adjustable wrench head of claim 15, wherein the material is removable.

17. A method, comprising:
receiving one or more knurled surfaces, of a threaded connector, within a span of an adjustable wrench device, the span including at least a first contact surface and a second contact surface dimensioned to engage at least partially the one or more knurled surfaces;
adjusting the span of the adjustable wrench device in order to cause the first contact surface to move toward the second contact surface and engage the threaded connector; and
applying a force to the adjustable wrench device to rotate the threaded connector using the first contact surface and the second contact surface engaged with the one or more knurled surfaces.

18. The method of claim 17, further comprising:
positioning the threaded connector at a threaded opening before applying a force to the adjustable wrench device.

19. The method of claim 17, wherein rotation of the threaded connector causes engagement or disengagement of the threaded connector with a threaded opening.

20. The method of claim 17, wherein applying the force to the adjustable wrench device further comprises:
moving the threaded connector toward a third contact surface of the adjustable wrench device by transferring the force to the threaded connector at angle of one of the first contact surface or the second contact surface.
